(19) United States
(12) Patent Application Publication
(10) Pub. No.: US 2011/0138584 A1
(43) Pub. Date: Jun. 16, 2011

(54) CLAMP DEVICE FOR TELESCOPIC POLES

(75) Inventor: JAMES E. WILD, Canton, OH (US)

(73) Assignee: Union Metal Corporation, Canton, OH (US)

(21) Appl. No.: 12/940,392

(22) Filed: Nov. 5, 2010

Related U.S. Application Data
(60) Provisional application No. 61/286,943, filed on Dec. 16, 2009.

(51) Int. Cl. F16B 2/06

(52) U.S. Cl. 24/457

(57) ABSTRACT

A clamp is designed and built for a particular application. The clamp may be affixed to, or attached at a specific joint on an existing telescopic pole structure. The clamp may be made in two or more sections that comprise shells that have been shaped to match the outside diameters of both sections of the existing telescopic joint.

### CROSS REFERENCE TO PRIOR APPLICATIONS

This application claims priority to and the benefit thereof, under 35 U.S.C. §119(e), from a U.S. Provisional Patent Application, No. 61/286,943, filed on Dec. 16, 2009, which is hereby incorporated herein by reference for all purposes as if fully set forth herein.

### BACKGROUND OF THE DISCLOSURE

1. Field of the Disclosure

This disclosure is directed to a novel method and a novel device for preventing fatigue damage to telescopic poles.

2. Related Art

Telescopic pole joints are frequently used to secure telescopic poles, which are used to support, among other things, billboards, signs, and the like. There have been many failures of telescopic pole joints due to fatigue loading caused by fluctuating winds. In many instances, the industry can not remove the existing poles without losing the rights to erect new ones of similar size at the same location.

### SUMMARY OF THE DISCLOSURE

In one aspect of the disclosure, a clamp may be designed and built for a particular application. The clamp may be affixed to, or attached at a specific joint on an existing telescopic pole structure. The clamp may include two or more portions that may comprise steel shells. The shells may be shaped to match the outside diameter(s) of an existing telescopic joint. These shaped shells may be welded to connecting plates and stiffeners. The clamp portions may be positioned at the specific joint and fastened together. The fasteners may be properly tightened and checked for initial tensioning. The clamp is configured to reinforce an existing joint in such a way as to prevent fatigue failure regardless of the number of fatigue cycles the existing joints may have already experienced.

According to a further aspect of the disclosure, a clamp is disclosed that is adapted to reinforce a joint between a first telescopic tower pole portion and a second telescopic tower pole portion to prevent fatigue failure that is independent of a number of fatigue cycles that the joint may have experienced. The clamp comprises: a first clamp portion that includes a first shell and a second shell; a second clamp portion that includes the second shell; a connecting plate that is configured to be attached to the first clamp portion and to the second clamp portion; a stiffener that is configured to provided added tensile strength to the first clamp portion and the second clamp portion; and a gusset that is attached to the second shell and the connecting plate, wherein the first shell is adapted to engage the first telescopic tower pole portion and the second shell is adapted to engage the second telescopic tower pole portion. A diameter of the first shell may be smaller than a diameter of the second shell. The connecting plate may be coupled to the first shell and/or the second shell. The stiffener may be attached to at least one of the first shell and the second shell.

According to a further aspect of the disclosure, a clamp is disclosed that is adapted to reinforce a joint between a first telescopic tower pole portion and a second telescopic tower pole portion to prevent fatigue failure that is independent of a number of fatigue cycles that the joint may have experienced. The clamp comprises: a first clamp portion that includes a first shell and a second shell; and a second clamp portion that includes the second shell, wherein the first shell is adapted to engage the first telescopic tower pole portion and the second shell is adapted to engage the second telescopic tower pole portion. A diameter of the first shell may be smaller than a diameter of the second shell.

The clamp may further comprise a connecting plate that is configured to receive a plurality of fasteners to secure the first clamp portion and the second clamp portion to a clamp section. The connecting plate may be coupled to at least one of the first shell and the second shell.

The clamp may further comprise a stiffener that is configured to provide additional tensile strength to at least one of the first clamp portion and the second clamp portion. The stiffener may be attached to at least one of the first shell and the second shell.

The clamp may further comprise a gusset that is configured to provide additional strength to at least one of the first clamp portion and the second clamp portion.

According to a further aspect of the disclosure, a method is disclosed for reinforcing a joint between a first telescopic tower pole portion and a second telescopic tower pole portion to prevent fatigue failure that is independent of a number of fatigue cycles that the joint may have experienced. The method comprises: welding a coupling plate to an outer shell to form a lower clamp portion; welding an inner shell to the coupling plate to form an upper clamp portion; and inspecting the welding to ensure secure binding of the first shell, the second shell and the coupling plate.

The method may further comprise finishing a surface of at least one of the lower clamp portion and the upper clamp portion. The finishing may comprise: painting the at least one of the lower clamp portion and the upper clamp portion; or galvanizing the at least one of the lower clamp portion and the upper clamp portion.

The method may further comprise: welding a stiffener to at least one of the outer shell and the inner shell; welding a gusset to at least one of the outer shell and the coupling plate; and/or attaching the coupling plate to a clamp section. The joint may be located proximate to a lower-most edge of the inner shell.

Additional features, advantages, and embodiments of the disclosure may be set forth or apparent from consideration of the following detailed description and drawings. Moreover, it is to be understood that both the foregoing summary of the disclosure, the following detailed description and drawings are exemplary and intended to provide further explanation without limiting the scope of the disclosure.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 illustrates a perspective view of an example of a clamp attached to a portion of a telescopic pole, according to principles of the disclosure; and

FIG. 2 shows an outer view of a portion of the clamp of FIG. 1;

FIG. 3 shows a perspective, inner view of a portion of the clamp of FIG. 1;

FIG. 4 shows an inner view of the portion of the clamp of FIG. 3;

FIG. 5 shows a side view of the portion of the clamp of FIG. 3;

FIG. 6 shows a top view of the portion of the clamp of FIG. 3; and

FIG. 7 shows a process for attaching the clamp to a telescopic pole.

The present disclosure is further described in the detailed description that follows.

### DETAILED DESCRIPTION OF THE DISCLOSURE

The embodiments of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

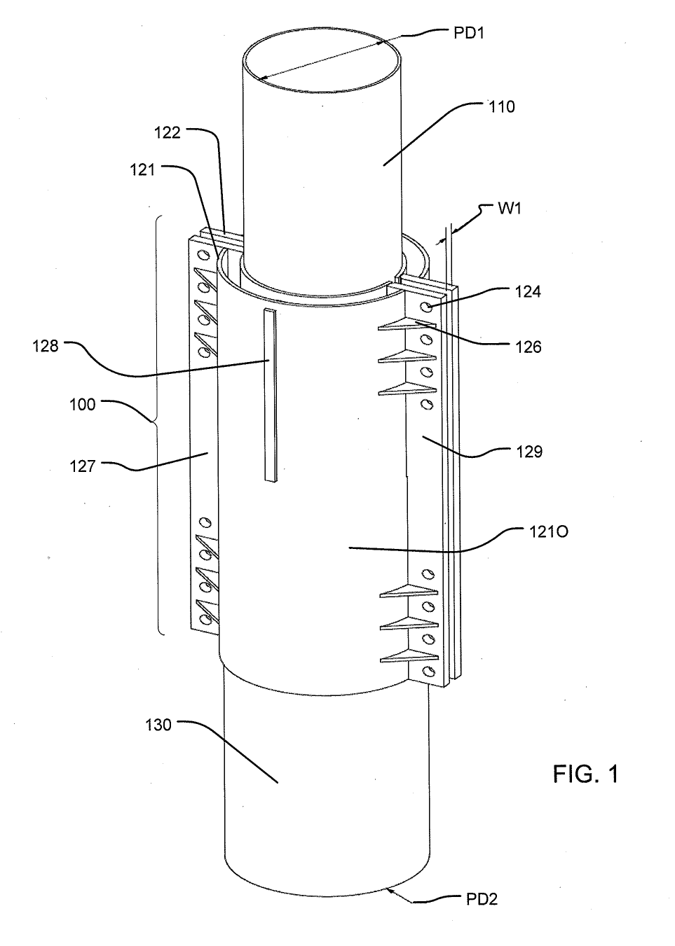

FIG. 1 illustrates a perspective view of an example of a clamp 100 attached to an upper telescopic tower pole portion 110 and a lower telescopic tower pole portion 130. In particular, the clamp 100 is attached to the joint between the upper telescopic pole portion 110 and lower telescopic pole portion 130. The upper telescopic pole portion 110 has a diameter PD1 and the lower telescopic pole portion 130 has a diameter PD2. The clamp 100 may include at least two clamp sections 121, 122. The clamp sections 121, 122, may be configured to be substantially the same, or the clamp sections 121, 122, may differ in various aspects, as will be readily appreciated and recognized by those having ordinary skill the art, without departing from the scope or spirit of the disclosure.

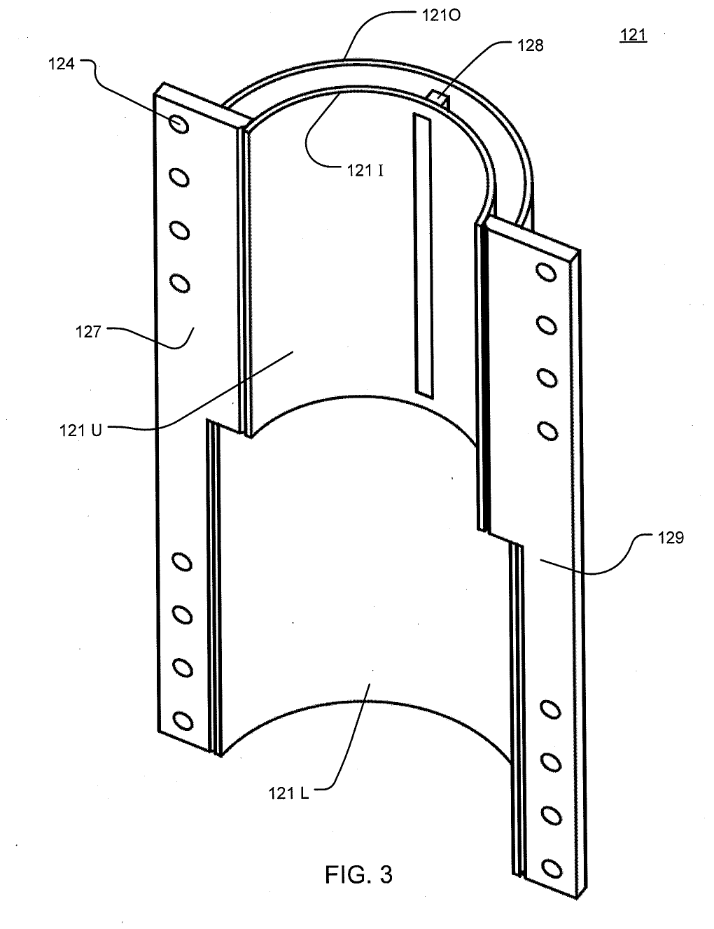

The clamp section 121 may include a plurality of connecting plates 127, 129, an outer shell 121O, a stiffener 128, and an inner shell 121I (shown in FIG. 3). The clamp section 121 may include additional shells (not shown) between the inner shell 121I and outer shell 121O. The clamp section 121 may further include one or more openings 124 and one or more gussets 126. When attached to the upper telescopic pole portion 110 and the lower telescopic pole portion 130, the clamp sections 121, 122, may form a gap having a width of W1.

It is noted that the clamp section 122 may be configured similar to the clamp section 121, so the description provided with respect to the clamp section 121 may equally describe the clamp section 122.

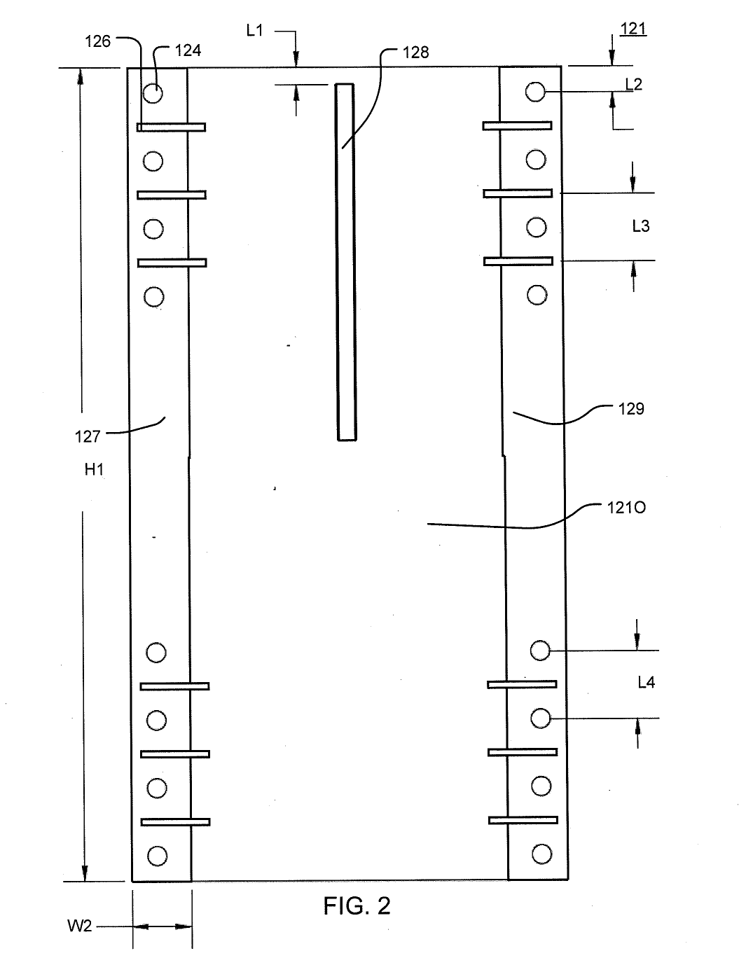

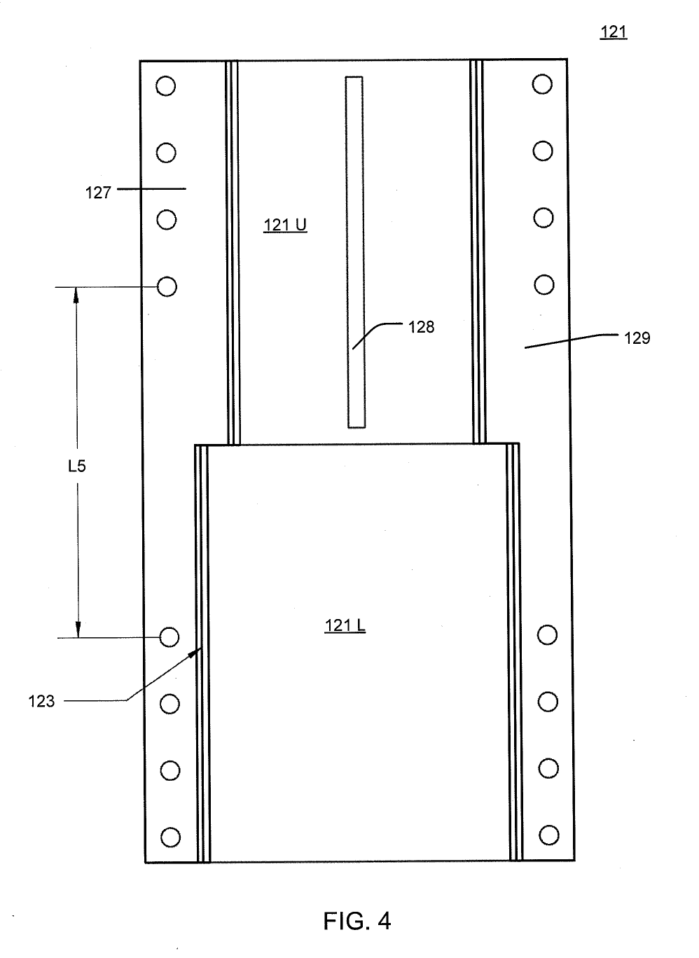

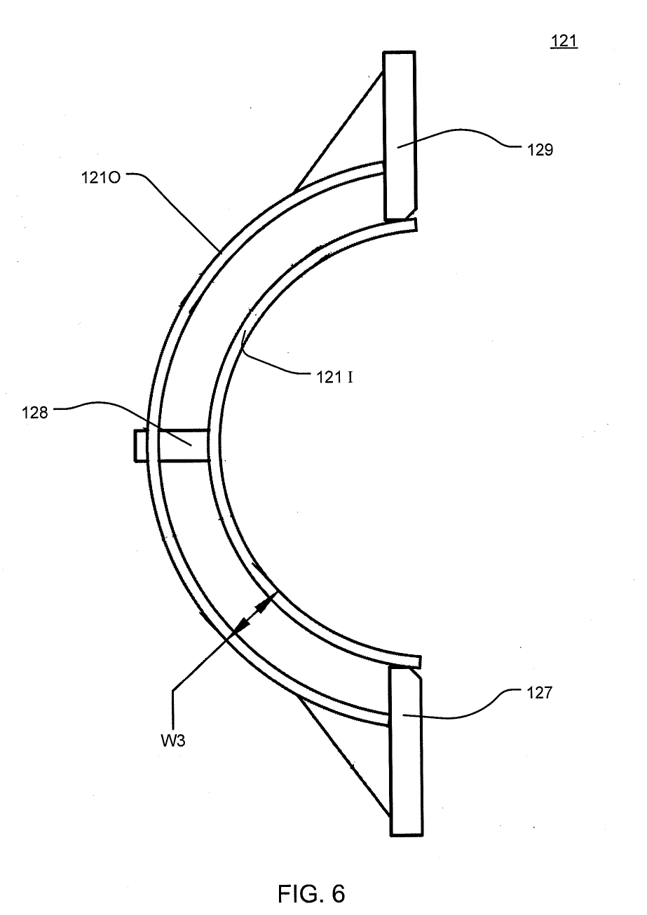

FIG. 2 shows an outer view of the clamp section 121. As seen in FIG. 2, the one or more openings 124 may be formed in the connecting plates 127, 129. The one or more gussets 126 may be formed (or attached) between the outer shell 121O and the connecting plate 127 (or 129). The one or more gussets 126 may be integrally formed with the outer shell 121O and the connecting plate 127 (or 129). The clamp section 121 may have a height H1. The stiffener 128 may be positioned at a distance L1 from the edge of the clamp section 121. A first opening 124 may be provided at a distance L2. The connecting plates 127, 129, may have a width W2. The gussets 126 may be spaced at a distance L3 from each other. Similarly, the openings 124 may be spaced at a distance L4 from each other, where L3 may be substantially the same as, or different from L4. The openings 124 that are nearest to the middle of the clamp section 121 (or 122) may be spaced apart by a distance L5 (shown in FIG. 4). The outer 121O and inner 121I shells may be separated by a width W3 (shown in FIG. 6).

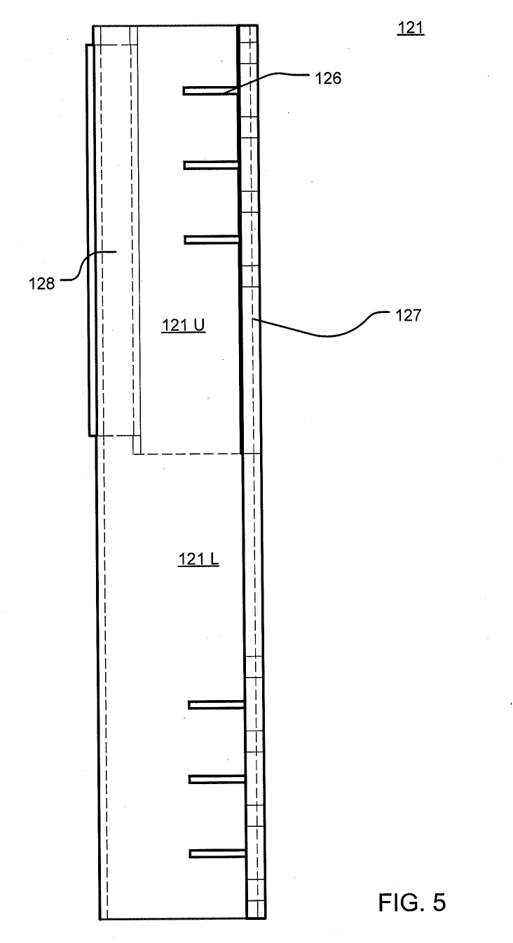

FIGS. 3-6 show various views of the clamp section 121. In particular, FIG. 3 shows a perspective, inner view of the clamp section 121; FIG. 4 shows an inner view of the clamp section 121; FIG. 5 shows a side view of the clamp section 121; and FIG. 6 shows a top view of the clamp section 121.

Referring to FIG. 3, the clamp section 121 includes an upper clamp portion 121U and a lower clamp portion 121L. The upper clamp portion 121U may include the inner shell 121I and the outer shell 121O. The lower clamp portion 121L may include the outer shell 121O. The upper claim portion 121U has an inner diameter that is smaller than the inner diameter of the lower clamp portion 121L. The clamp section 121 may be configured such that the inside diameter of the outer shell 121O and the inside diameter of the inner shell 121I match the outside diameters of a telescopic tower joint. The material grades, thicknesses and dimensions may be calculated for each particular joint.

Referring to FIG. 4, a weld 123 may be provided between the connecting plate 127 (or 129) and the inner and outer shells 121I and 121O, respectively.

### Example

According to one, non-limiting example of the disclosure, the clamp 100 and the telescopic tower pole portions 110, 130 may be constructed from a material such as, for example, steel, which may have the following non-limiting examples of grades, thicknesses and dimensions (Tables 1-4).

TABLE 1
Upper Tower Pole Portion 110

| | | |
|---|---|---|
| Outer diameter PD1 | 24 | in. (inches) |
| Wall thickness | 0.375 | in. |
| Material yield | 35 | ksi. (kilopound-per-in.²) |
| Section modulus | 161.8586 | in.³ |
| Moment of inertia | 1942.283 | in.⁴ |
| Allow bending moment | 3738.934 | k-in. (kilopound-per-in.) |

TABLE 2
Lower Telescopic tower pole portion 130

| | | |
|---|---|---|
| Outer diameter PD2 | 30 | in. |
| Wall thickness | 0.5 | in |
| Material yield | 35 | ksi |
| Section modulus | 336.1479 | in.³ |
| Moment of inertia | 5042.168 | in.⁴ |
| Allow bending moment | 7765.017 | k-in. |

TABLE 3
Upper Clamp Portion 121U

| | | |
|---|---|---|
| Inner diameter of shell 121O | 30 | in. |
| Inner diameter of shell 121I | 24 | in. |
| Wall thickness of shell 121O | 0.375 | in. |
| Wall thickness of shell 121I | 0.375 | in. |
| Material yield | 36 | ksi. |
| Section modulus | 407.2074 | in.³ |
| Moment of inertia shell 121O | 4127.649 | in.⁴ |
| Moment of inertia shell 121I | 2133.165 | in.⁴ |
| Allow bending moment | 9675.248 | k-in. |

TABLE 4
Lower Clamp Portion 121L

| | | |
|---|---|---|
| Inner diameter of shell 121O | 30 | in. |
| Wall thickness of shell 121O | 0.375 | in |
| Material yield | 36 | ksi |
| Section modulus | 268.4677 | in.³ |
| Moment of inertia | 4127.649 | in.⁴ |
| Allow bending moment | 6378.793 | k-in. |

In the example of Tables 1-4, the clamp 100 may have, for example, but is not limited to, the following approximate values for the dimensions H1, L1-L5 and W1-W3 (shown in FIGS. 1, 2, 4, and 6): H1=61 in.; L1=1 in.; L2=4 in.; L3=5 in.; L4=5 in.; L5=23 in.; W1=1 in.; W2=6.25 in.; and W3=5.625 in. In this example, each gusset 126 may have a thickness of, for example, about 0.5 in., and a combined weight of, for example, about 55 lbs for all of the gussets 126. The allowable momentum between the gusset 126 and the connecting plate 127 (or 129) may be, for example, about 25.40036 k-in., where the connecting plate 127 (or 129) may have a minimum thickness of, for example, about 1.133 in., with a preferred thickness of about 1.25 in. The fasteners (not shown) may each be provided at an equivalent load of, for example, about 162 k with an allowable material yield of, for example, about 39.5 ksi., a tensile area of, for example, about 1.03 in.², and a diameter of, for example, about 1.5 in. The outside shell 121O may have a weight of, for example, about 447 lbs.; the inner shell 121I may have a weight of, for example, about 179 lbs.; the stiffener 128 may have a weight of, for example, about 61 lbs.; the connecting plates 127, 129 may have a weight of, for example, about 195 lbs.; and the welds 123 may have a weight of, for example, about 13 lbs. The surfaces of the clamp 100 may be provided with a galvanized finish that may weigh, for example, about 48 lbs.

While the foregoing examples of material grades, thicknesses and dimensions may be used for the clamp 100, other material grades, thicknesses and dimensions may be used for the clamp 100 without departing from the scope or spirit of the disclosure.

Welds 123 may be provided as described above. All welds 123 may be inspected by NDT methods appropriate for each type of weld. Material certifications may be provided for all, or some of the materials used in the clamp 100.

The clamp sections 121, 122, may be, for example, hot dipped galvanized to provide longevity and strength. The clamp 100 may be painted to match the telescopic tower.

The strength of each telescopic tower joint may be determined based on, for example, maximum allowable loading of the upper section of the joint per AISC, ANCI, or appropriate building code. The connecting plates 127, 129, may have gussets 126 between each opening 124 and at both ends of the clamp section 121 (122). The dimensions of the gussets 126 and/or openings 124 may be determined by calculation for each joint.

The clamp sections 121, 122, may be connected by fasteners, such as, for example, but not limited to, bolts and nuts. For example, the fasteners may include ASTM A325 or A490 compliant bolts with appropriate flat and lock washers and nuts. The number, spacing, size and grade of the fasteners may be based on allowable moment of the upper section of the joint, as will be understood by those having ordinary skill in the relevant art.

Generally, the clamp 100 may be designed and built for each specific joint of a telescopic tower to be retro-fitted, or fitted for the first time.

While the clamp 100 has been described as being, made from steel, it is noted that the clamp 100 may be made from other materials, including, for example, plastic, fiberglass, synthetic fibers, and the like. The clamp sections 121, 122 may be formed as unitary structures by a process, such as, for example, injection molding, or the like.

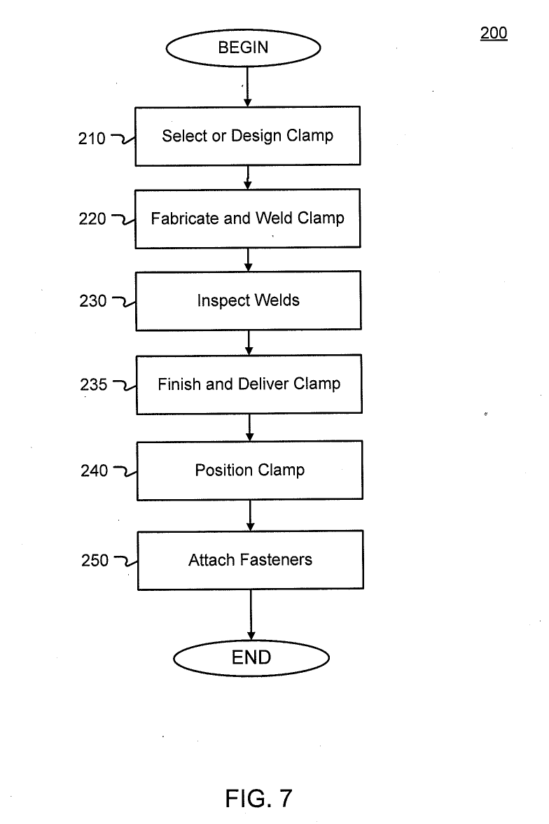

FIG. 7 shows a process for fabricating and attaching the clamp 100 to a telescopic pole tower. Initially, the clamp 100, including clamp sections 121, 122, is selected or designed for a particular telescopic joint (Step 210). The inner shell 121I may be welded to the outer shell 121O and the connecting plates 127, 129 to fabricate the clamp 100 (Step 220). Further, the stiffener 128 may be welded between the outer shell 121O and the inner shell 121I, and the plurality of gussets 126 may be welded to at least one of the outer shell 121O and the coupling plate 127, 129 (Step 220). The welds may be inspected by, for example, NDT methods appropriate for each type of weld (Step 230). The welded clamp 100 may be finished by, for example, galvanizing, painting, powdering, or the like, the clamp 100 and delivering the finished clamp to the installation location (Step 235). At the installation location, the clamp sections 121, 122, may be lifted into position and aligned as determined by field conditions, customer requirements, or the like (Step 240). The clamp sections 121, 122 may be positioned such that the joint between the upper telescopic tower pole portion 110 and lower telescopic tower pole portion 130 may be located proximate to a lower-most edge of the inner shell 121I. Once positioned appropriately, fasteners (for example, bolts) may be placed into the openings 124 and tightened (Step 250). All fasteners may be tightened to a proper pretension using, for example, a calibrated torque wrench (not shown) where the fasteners are bolt-nut combinations. In this regard, the threads on the bolts may be interrupted or a second nut may be placed and tightened on each bolt to prevent loosening of the bolts.

While the disclosure has been described in terms of exemplary embodiments, those skilled in the art will recognize that the disclosure can be practiced with modifications in the spirit and scope of the appended claims. These examples given above are merely illustrative and are not meant to be an exhaustive list of all possible designs, embodiments, applications or modifications of the disclosure.

What is claimed is:

1. A clamp that is adapted to reinforce a joint between a first telescopic tower pole portion and a second telescopic tower pole portion to prevent fatigue failure that is independent of a number of fatigue cycles that the joint may have experienced, the clamp comprising:
a first clamp portion that includes a first shell and a second shell;
a second clamp portion that includes the second shell;
a connecting plate that is configured to be attached to the first clamp portion and to the second clamp portion;
a stiffener that is configured to provided added tensile strength to the first clamp portion and the second clamp portion; and
a gusset that is attached to the second shell and the connecting plate,
wherein the first shell is adapted to engage the first telescopic tower pole portion and the second shell is adapted to engage the second telescopic tower pole portion.

2. The clamp according to claim 1, wherein the first shell comprises a diameter that is smaller than a diameter of the second shell.

3. The clamp according to claim 1, wherein the connecting plate is coupled to the first shell.

4. The clamp according to claim 1, wherein the connecting plate is coupled to the second shell.

5. The clamp according to claim 1, wherein the connecting plate is coupled to the first shell and the second shell.

6. The clamp according to claim 1, wherein the stiffener is attached to at least one of the first shell and the second shell.

7. A clamp that is adapted to reinforce a joint between a first telescopic tower pole portion and a second telescopic tower pole portion to prevent fatigue failure that is independent of a number of fatigue cycles that the joint may have experienced, the clamp comprising:
a first clamp portion that includes a first shell and a second shell; and
a second clamp portion that includes the second shell,
wherein the first shell is adapted to engage the first telescopic tower pole portion and the second shell is adapted to engage the second telescopic tower pole portion.

8. The clamp according to claim 7, wherein the first shell comprises a diameter that is smaller than a diameter of the second shell.

9. The clamp according to claim 1, further comprising:
a connecting plate that is configured to receive a plurality of fasteners to secure the first clamp portion and the second clamp portion to a clamp section.

10. The clamp according to claim 9, wherein the connecting plate is coupled to at least one of the first shell and the second shell.

11. The clamp according to claim 7, further comprising:
a stiffener that is configured to provide additional tensile strength to at least one of the first clamp portion and the second clamp portion.

12. The clamp according to claim 11, wherein the stiffener is attached to at least one of the first shell and the second shell.

13. The clamp according to claim 7, further comprising:
a gusset that is configured to provide additional strength to at least one of the first clamp portion and the second clamp portion.

14. A method for reinforcing a joint between a first telescopic tower pole portion and a second telescopic tower pole portion to prevent fatigue failure that is independent of a number of fatigue cycles that the joint may have experienced, the method comprising:
welding a coupling plate to an outer shell to form a lower clamp portion;
welding an inner shell to the coupling plate to form an upper clamp portion; and
inspecting the welding to ensure secure binding of the first shell, the second shell and the coupling plate.

15. The method according to claim 14, further comprising:
finishing a surface of at least one of the lower clamp portion and the upper clamp portion.

16. The method according to claim 15, wherein the finishing comprises:
painting the at least one of the lower clamp portion and the upper clamp portion; or
galvanizing the at least one of the lower clamp portion and the upper clamp portion.

17. The method according to claim 14, further comprising:
welding a stiffener to at least one of the outer shell and the inner shell.

18. The method according to claim 14, further comprising:
welding a gusset to at least one of the outer shell and the coupling plate.

19. The method according to claim 14, further comprising:
attaching the coupling plate to a clamp section.

20. The method according to claim 19, wherein the joint is located proximate to a lower-most edge of the inner shell.
